(19) United States
(12) Patent Application Publication
(10) Pub. No.: US 2017/0349481 A1
(43) Pub. Date: Dec. 7, 2017

(54) TRANSPARENT CONDUCTOR COMPRISING METAL NANOWIRES, AND METHOD FOR FORMING THE SAME

(71) Applicant: SOLVAY SA, Brussels (BE)

(72) Inventors: Marc LACROIX, Ottignies - Louvain-La-Neuve (BE); Placido GARCIA-JUAN, Bernburg (DE)

(21) Appl. No.: 15/536,727

(22) PCT Filed: Dec. 15, 2015
(86) PCT No.: PCT/EP2015/079855

§ 371 Date: Jun. 16, 2017

(30) Foreign Application Priority Data
Dec. 16, 2014 (EP) 14198268.6

(51) Int. Cl. C03C 17/00; G06F 3/041; H01B 1/08; H01B 1/02; H01B 13/00; H01B 5/14

(52) U.S. Cl. CPC C03C 17/007; H01B 13/0036; H01B 5/14; H01B 1/08; H01B 1/02; G06F 3/041; C03C 17/008; C03C 2218/116; C03C 2217/948; C03C 2217/479; C03C 2217/465; C03C 2217/45; G06F 2203/04103

(57) ABSTRACT

Disclosed are transparent conductors comprising a substrate, and a conductive layer formed on the substrate, wherein the conductive layer comprises a first conductive medium comprising a plurality of metal nanowires, and a second conductive medium comprising a plurality of conductive nanoparticles, and methods for forming the same.

This application claims priority to European patent application No. 14198268.6 filed on Dec. 16, 2014, the whole content of the application being incorporated herein by reference for all purposes.

### TECHNICAL FIELD

The present invention relates to a transparent conductor comprising a conductive metal nanowire network, and a method for forming the same. The invention also relates to an electronic device comprising such transparent conductor.

### BACKGROUND OF THE INVENTION

Transparent conductors are optically transparent, thin conductive materials. Such materials have wide variety of applications, such as transparent electrodes in displays such as liquid crystal displays (LCD), plasma displays, and organic light-emitting diode (OLED), touch panels, photovoltaic cells, electrochromic devices, and smart windows, as anti-static layers and as electromagnetic interference shielding layers.

Conventional transparent conductors include metal oxide films, in particular indium tin oxide (ITO) film due to its relatively high transparency at high conductivity. However, ITO has several shortcomings, such as high cost during its fabrication because it needs to be deposited using sputtering which involves high temperatures and vacuum chambers. Metal oxide films are also fragile and prone to damage even when subjected to minor physical stresses such as bending, and as such, often does not applicable when a flexible substrate on which the metal oxide film is to be deposited is used.

PCT international patent application publication No. WO 2008/131304 A1 discloses composite transparent conductors formed of at least two types of transparent conductive media, in particular the composite transparent conductor including silver nanowires as a primary conductive medium, and a secondary conductive medium coupled to the primary conductive medium which is typically a conductive network of a second type of conductive nanostructures, or a continuous conductive film formed of conductive polymers or metal oxides.

A high-performance nanostructure-based transparent conductors which satisfy the increasing demand for in rapidly-changing electronics application, in particular for display systems, is demanded in the art.

### DESCRIPTION OF THE INVENTION

The purpose of the present invention is to provide a high performance transparent conductor comprising metal nanowire network, which can be suitably used as the transparent conductive material in electronic device application. Another purpose of the invention is to provide a transparent conductor comprising metal nanowire network, which exhibits excellent surface morphology. Further purpose of the present invention is to provide a transparent conductor comprising metal nanowire network, which exhibits homogeneous sheet resistance. Still further purpose of the present invention is to provide a transparent conductor comprising metal nanowire network, which shows good conduction in terms of vertical current circulation to the surface. Yet further purpose of the present invention is to provide a transparent conductor comprising metal nanowire network, which exhibits good lateral carrier collection.

The present invention relates to transparent conductors comprising a substrate; and a conductive layer formed on the substrate, wherein the conductive layer comprises a first conductive medium comprising a plurality of particular metal nanowires, and a second conductive medium comprising a plurality of particular conductive nanoparticles.

In particular, the present invention concerns a transparent conductor comprising a substrate; and a conductive layer formed on the substrate, wherein the conductive layer comprises a first conductive medium comprising a plurality of metal nanowires, and a second conductive medium comprising a plurality of conductive nanoparticles, characterized in that an average diameter of the metal nanowires is from 20 nm to 50 nm, and an average particle size of the conductive nanoparticles is from 10 nm to 30 nm, as measured by transmission electron microscope (TEM).

Indeed, it has been found by the present inventors that the superior performance as a transparent conductor can be attained by the conductor according to the invention. It has been found that the transparent conductor of the present invention can attain one or more purposes described in the above. Also, it has been found that the particular conductive layer formed in the transparent conductor according to the present invention can meet one or more properties required in the art, including superior transparency, demanding sheet resistance, and excellent haze, or inter alia all of them. Another surprising finding by the present inventors includes superior resistance of the transparent conductor against long term aging, which is often necessary for its commercial use. It has been also found in the present invention that excellent surface morphology can be obtained by the transparent conductor of the present invention. It has been found that homogeneous sheet resistance can be achieved in the transparent conductor of the present invention. It has been found that good conduction in terms of vertical current circulation to the surface and/or good lateral carrier collection can be attained by the transparent conductor of the present invention.

Further, the present invention provides an electronic device, in particular touch panel, comprising the transparent conductor according to the present invention.

### DETAILED DESCRIPTION OF THE INVENTION

The transparent conductor of the present invention comprises a substrate; and a conductive layer.

In the present invention, the term “substrate” is understood to denote in particular a solid, especially a transparent solid, i.e. light transmission of the substrate is at least 70% (preferably at least 85%, more preferably at least 90%, still more preferably at least 95%, particularly preferably at least 98%) in the visible light region (400 nm to 700 nm), on which a layer of the transparent conductor according to the present invention can be deposited. Examples of such substrates include a glass substrate, and transparent solid polymers, for example polycarbonates (PC), polyesters, such as polyethyleneterephthalate (PET), acryl resins, polyvinyl resins, such as polyvinyl chloride, polyvinylidene chloride, and polyvinyl acetals, aromatic polyamide resins, polyamideimides, polyethylene naphthalene dicarboxylate, polysulphones, such as polyethersulfone (PES), polyimides (PI), cyclic olefin copolymers (COC), styrene copolymers, polyethylene, polypropylene, cellulose ester bases, such as cellulose triacetate, and cellulose acetate, and any combination thereof. Preferably, the substrate is in the form of a sheet. In the present invention, the substrate may be rigid or flexible. Examples of the flexible substrate include, but are not limited to, those transparent solid polymers, including polycarbonates, polyesters, polyolefins, polyvinyls, cellulose ester bases, polysulphones, polyimides, and other conventional polymeric films.

In the present invention, the conductive layer at least comprises a first conductive medium comprising a plurality of metal nanowires. When deposited on the substrate, the nanowires are usually present so as to intersect each other to form a conductive metal nanowire network having plurality of intersections of metal nanowire. Thus, the conductive layer in the present invention can comprise a first conductive medium comprising at least one metal nanowire network.

In the present invention, an average diameter of the metal nanowires is from 20 nm to 50 nm, preferably 25 nm to 45 nm, more preferably 30 nm to 45 nm. In the present invention, the diameter of the metal nanowires can be measured by transmission electron microscope (TEM). An average length of the metal nanowires in the present invention is often in the range of 1 μm to 100 μm. The average length of the metal nanowires is preferably at least 10 μm, more preferably more than 10 μm, still more preferably at least 15 μm. The average length of the metal nanowires is preferably equal to or less than 50 μm, more preferably equal to or less than 30 μm, still more preferably equal to or less than 20 μm. In the present invention, the length of the metal nanowires can be measured by optical microscope.

In the present invention, the metal nanowires can be nanowires formed of metal, metal alloys, plated metals or metal oxides. Examples of the metal nanowires include, but are not limited to, silver nanowires, gold nanowires, copper nanowires, nickel nanowires, gold-plated silver nanowires, platinum nanowires, and palladium nanowires. Silver nanowires are the most preferred metal nanowires in the present invention because of its high electrical conductivity.

Excellent result can be obtained when a silver nanowire having an average diameter of 30 nm to 45 nm and an average length of 15 to 20 μm is used as the first conductive medium.

In the present invention, the conductive layer comprises, in addition to the first conductive medium, a second conductive medium comprising a plurality of conductive nanoparticles. The plurality of conductive nanoparticles often forms a matrix in which the metal nanowire network can be embedded.

In the present invention, the term “nanoparticles” is intended to denote in particular solid particles of which the majority has a size higher than or equal to 1 nm but no more than 1 μm, especially no more than 500 nm, and of which shape is spherical or substantially spherical, particularly having an average aspect ratio of about 1.2 or lower, more particularly of about 1.1 or lower.

In the present invention, an average particle size of the conductive nanoparticles is from 10 nm to 30 nm, more preferably 10 nm to 27 nm. In the present invention, the particles size of the conductive nanoparticles can be measured by transmission electron microscope (TEM).

In the present invention, the conductive nanoparticles are preferably selected from the group consisting of the metallic elements in Groups 13 to 16 of the periodic table (Al, Ga, In, Sn, Tl, Pb, Bi, and Po), transition metals, mixtures of at least two metallic elements of the afore-mentioned, chalcogenides, in particular oxides thereof, and any combination thereof. More preferably, the conductive nanoparticle in the present invention is selected from metal oxide nanoparticles. Indium tin oxide (ITO) nanoparticle is particularly preferred in the present invention. Alternatively, zinc oxide and tin oxide nanoparticles, such as undoped or aluminum doped zinc oxide and undoped or antimony or fluorine doped tin oxide nanoparticles, may be used in the present invention.

In the present invention, the conductive nanoparticles are preferably applied to the substrate via wet process. In other words, the conductive nanoparticles are preferably prepared in solution form before its application.

In the present invention, a conductive nanoparticle ink is particularly preferably used in forming the second conductive medium. The conductive nanoparticle ink often comprises (a) conductive nanoparticles, (b) solvent, and optionally (c) one or more additives.

In the present invention, the conductive nanoparticle ink preferably comprises (a) conductive nanoparticles having an average primary particle size of 10 nm to 30 nm, preferably 10 nm to 27 nm, and an average secondary particle size of no more than 100 nm, particularly no more than 60 nm. In the present invention, the conductive nanoparticles are preferably present in the conductive nanoparticle ink in an amount equal to or higher than 5 wt %, especially equal to or higher than 10 wt %, more specifically equal to or higher than 15 wt %, relative to the total weight of the ink composition. The nanoparticles are preferably present in the conductive nanoparticle ink in an amount of no more than 55 wt %, especially no more than 45 wt %, more specifically no more than 35 wt %, relative to the total weight of the ink composition. Alternatively, the nanoparticles may present in the conductive nanoparticle ink in the amount of equal to or higher than 10 wt % and no more than 50 wt %. ITO nanoparticle is especially preferred conductive nanoparticle to be used in the conductive nanoparticle ink in the present invention (i.e. ITO ink).

(b) Solvent to be used in the ink composition can be chosen among those disclosed in the PCT international patent application publication No. WO2013/050337A, which, by its entirety, is incorporated herein by reference. Alcohols, such as ethanol, isopropanol, n-butanol, 2-isopropoxyethanol, 2-isopropoxyethanol, or a mixture thereof, can be suitably used as (b) solvent for the conductive nanoparticle ink in the present invention. An amount of the solvent usually makes up the remainder of the conductive nanoparticle ink composition, except for the other components, such as (a) and (c).

Particular type of the (c) additive includes a binder. Thus, the conductive nanoparticle ink of the present invention preferably comprises at least one binder. For the typical examples of the binder as well as other additives for the conductive nanoparticle ink in the present invention, reference can be made to the above-mentioned PCT international patent application publication No. WO2013/050337A.

For the process for the manufacture of the first and second conductive medium on the substrate, any wet process employed for the formation of conductive layer known in the art can be suitably used. Such wet process preferably comprises applying a solution comprising the metal nanowires or the conductive nanoparticles on a surface of the substrate, and drying and optionally curing the solution spread on the surface.

For instance, upon being applied on the substrate, the metal nanowires can be dispersed in a solvent selected from the group consisting of water; aliphatic alcohols, such as methanol, ethanol, isopropanol, butanol, n-propylalcohol, ethylene glycol, propylene glycol, butanediol, neopentyl glycol, 1,3-pentanediol, 1,4-cyclohexanedimethanol, diethyleneglycol, polyethelene glycol, polybutylene glycol, dimethylolpropane, trimethylolpropane, sorbitol, esterification products of the afore-mentioned alcohols; aliphatic ketones, such as cellosolve, propyleneglycol methylether, diacetone alcohol, ethylacetate, butylacetate, acetone and methylethylketone; ethers such as tetrahydrofuran, dibutyl ether, mono- and polyalkylene glycol dialkyl ethers; aliphatic carboxylic acid esters; aliphatic carboxylic acid amides; aromatic hydrocarbons; aliphatic hydrocarbons; acetonitrile; aliphatic sulfoxides; and any combination thereof. Alcohols can be preferably used. In the present invention, the content of the metal nanowires in the solution can be from 0.01 wt % to 1 wt %, preferably 0.02 wt % to 0.5 wt %, more preferably 0.05 wt % to 0.2 wt %, relative to the total weight of the solution.

Optionally, the solution comprising the metal nanowires may contain one or more additives known in the art. Reference can be made to the disclosure of the United States Patent Application Publication No. US 2014/0203223 A.

As to the solution comprising the conductive nanowires, the above-explained conductive nanoparticle ink can be suitably used.

Examples of method of applying the solution on the substrate include wettings, such as dipping, coatings, such as spin coating, dip coating, slot-die coating, spray coating, flow coating, bar coating, meniscus coating, capillary coating, roll coating, and electro-deposition coating, and spreading, but the present invention is not limited thereto. The thickness of the first conductive medium on the substrate is preferably from 25 to 100 nm, more preferably 25 to 60 nm. The thickness of the second conductive medium on the substrate is preferably from 100 to 600 nm, more preferably 200 to 400 nm. The application of the solution may be conducted by applying the solution comprising the metal nanowires or the conductive nanoparticles on the substrate one time or two times or more. Drying may be performed under air or under inert atmosphere such as nitrogen or argon. Drying is typically conducted under atmospheric pressure or under reduced pressure, particularly under atmospheric pressure. Drying is usually conducted at a temperature sufficiently high to allow evaporation of the solvent. Drying may be performed at a temperature between 10 to 200° C. depending on selection of the solvent. Optional curing can be conducted by a subsequent treatment, such as a heat treatment and/or a treatment with radiation. Preferably, ultraviolet (UV) radiation in particular with a wavelength ranging from 100 nm to 450 nm, for example 172, 248 or 308 nm, can be suitably used. One or more optional treatment step, such as cleaning, drying, heating, plasma treatment, microwave treatment, and ozone treatment, may be conducted in any time during the process for the manufacture of conductive medium.

Therefore, another aspect of the present invention concerns a method for forming the transparent conductor of the present invention.

Preferably, a method for forming the transparent conductor according to the present invention comprises applying a first composition for forming the first conductive medium comprising the plurality of metal nanowires on a surface of the substrate; and applying a second composition for forming the second conductive medium comprising the plurality of conductive nanoparticles on the surface of the substrate in which the first conductive medium is formed. Without wishing to be bound by any theory, an application of the second conductive medium into the substrate on which the metal nanowire network is already formed may cause an effect of filling the vacant (or insulating) area surrounded by intersections of the metal nanowire network with the conductive nanoparticles, thereby forming a composite conductive layer. In the present invention, thickness of the conductive layer of the transparent conductor is preferably at least 2 times, more preferably 3 times, still more preferably 4 times, of the average diameter of the metal nanowire. In one embodiment of the present invention, the conductive layer of the transparent conductor has a thickness of at least 200 nm and no more than 400 nm.

In the present invention, the second conductive medium is preferably in physical contact and/or electrical connection with the first conductive medium. The first conductive medium comprising a plurality of metal nanowires is often embedded in the matrix formed by a plurality of conductive nanoparticles in the second conductive medium.

Incorporation of a proper amount of the conductive nanoparticles into the conductive metal nanowire medium is often believed to result in the risk of losing transparency because of the strong plasmon effect, and therefore, has not been preferable (for instance, see paragraph [0046] of the United States Patent Application Publication No. US 2014/0203223 A). However, contrary to the above belief, the transparent conductor of the present invention has been found that even though it comprises both conductive metal nanowires and distinct conductive nanoparticles, there is no substantial decrease in transparency or only minimum degree of transparency is lost. In a certain embodiment of the present invention, the transparency can even be increased by decreasing the diffraction in the conductive layer. Therefore, the transparent conductor according to the invention is surprisingly able to attain excellent one or more optical and electrical properties required in the art.

Despite its many advantages as conductive medium, a metal nanowire network alone often creates unfavorable surface morphology, in particular plural protrusions produced by overlapping wires. Height of such protrusions can be 2 to 3 times of the diameter of the metal nanowires. Such surface morphology often makes the use of metal nanowire network difficult, especially in the applications where the transparent conductor layer in the device needs to be very thin (often less than few hundreds nanometers). The thick protrusions often penetrate into an adjacent active layer, thereby causing short-circuit in the device. Also, a metal nanowire network along has plural lateral holes between the wires, which often causes the issues in the lateral carrier collection. In addition, the sheet resistance of metal nanowire network alone is not always homogeneous over the surface. The transparent conductor according to the present invention may address one or more of the above issues.

In particular, excellently-low surface roughness can be obtained by the transparent conductor of the present invention. In the present invention, the surface roughness can be measured by atomic force microscopy (AFM) analysis. Since the plurality of metal nanowires can be substantially embedded in the matrix formed by a plurality of conductive nanoparticles, the surface roughness which is substantially similar to that of conductive nanoparticle matrix can be obtained in the transparent conductor according to the present invention. Accordingly, the transparent conductor according to the present invention preferably possesses the root mean square (RMS) roughness, as measured by AFM analysis, of no more than 2 times of the diameter of the metal nanowire, preferably no more than the diameter of the metal nanowire, more preferably no more than half of the diameter of the metal nanowire. Especially, it has been surprisingly found that superior surface roughness, in particular RMS roughness as measured by AFM analysis of no more than 10 nm, can be attained by selecting the average diameter of metal nanowire of 20 nm to 50 nm in the transparent conductor system according to the present invention.

WO 2008/131304 A1 discloses composite transparent conductors including the ITO film first deposited on the substrate, and the ITO film sputtered on top of the nanowire film (e.g., FIG. 6B). However, sputtering ITO cannot cure the surface roughness issues caused by the protrusions in overlapped metal nanowires. Rather, the same or similar surface profile to that of the metal nanowire network is substantially maintained after the ITO sputtering on the nanowire film, the ITO sputtering being a substantially vertical deposition technique.

US 2013/0126796 A1 suggests transparent conductive layer comprising a conductive metal body layer as a first layer and a layer containing the conductive polymer and transparent conductive oxide as a second layer (paragraph [0064]). As opposed to the spherical or substantially spherical nanoparticles employed in the present invention, ITO flake having thickness 20 nm and diameter of 1 micron was used in this reference (Example 3). The substantially smooth surface morphology attainable in the present invention cannot be obtained by the use of ITO flake having diameter of 1 micron because the flake will in turn create other protrusions on the surface.

Thusly-formed conductive layer according to the present invention can attain excellent optical and electrical properties which are often required in the application of the transparent conductor. Accordingly, the conductive layer in the present invention possesses at least one, preferably two, more preferably all of the following characteristics:
a transparency to visible light of at least 80%, preferably at least 85%, more preferably at least 90%
a sheet resistance of no more than 1,000 Ω/square, preferably no more than 500 Ω/square, more preferably no more than 100 Ω/square
a haze of no more than 5%, preferably no more than 2%, more preferably no more than 1.5%

More preferably, at least one, preferably two, more preferably all of said characteristics can be met in the conductive layer comprising metal nanowire network embedded in a matrix formed by metal oxide nanoparticles.

In the present invention, the transparency (transmission) to visible light can be measured by using UV-VIS spectrometer at wavelength range from 400 nm to 800 nm. For instance, Haze-gard plus instrument (transparency function) available from BYK-Gardner (ASTM D 1003) can be used.

In the present invention, the sheet resistance can be measured using 4-point probes using R-CHEK Surface Resistivity Meter (Model #RC3175) available from EDTM Inc.

In the present invention, the haze can be measured using a haze-meter, for instance Haze-gard plus instrument (haze function) available from BYK-Gardner (ASTM D 1003).

The present invention can provide a metal-nanowire-based transparent conductor having exceptionally superior and balanced optical and electrical properties. Accordingly, further aspect of the present invention concerns a transparent conductor comprising a substrate and a conductive layer formed on the substrate, the conductive layer at least comprising a plurality of metal nanowires, characterized in that the conductive layer possesses all of the following characteristics:
a transparency to visible light of at least 90%
a sheet resistance of no more than 100 Ω/square
a haze of no more than 1.5%

Another superior effect attainable via the transparent conductor of the present invention is that the conductive layer has a good resistance against a change with the passage of the time (i.e. aging). In other words, the excellent optical and electrical properties, especially an excellent conductivity, attainable in the present invention do not substantially degrade (or its degree of the degradation can be significantly decreased) compared to the cases where bare metal-nanowire-based conductive layer is used.

Thusly, still another aspect of the present invention is related to a transparent conductor comprising a substrate and a conductive layer formed on the substrate, the conductive layer at least comprising a plurality of metal nanowires and possessing a sheet resistance value R, characterized in that variation of the sheet resistance value R does not exceed ±15% after exposing the conductive layer for 16 weeks at ambient environment.

The transparent conductor according to the present invention can also attain increased average current density (in terms of vertical current conduction) and/or lateral carrier collection compared to single metal nanowire network system.

The transparent conductor according to the present invention may be subject to one or more subsequent fabrication process. For instance, the transparent conductor can be patterned. For the methodologies of the patterning, reference can be made to the disclosures of the United States Patent Application Publication No. US 2014/0203223 A, which, by its entirety, is incorporated herein by reference.

The transparent conductor of the present invention and/or its fabricated structure, especially patterned structure thereof, can be used in various electronic devices in which a transparent conductor is suitably utilized. Examples of the application include touch panels, various electrodes for display devices, such as liquid crystal display (LCD) and organic light-emitting device (OLED), antistatic layers, electromagnetic interference (EMI) shields, touch-panel-embedded display devices, and photovoltaic (PV) cells, but the present invention is not limited thereto. The transparent conductor of the present invention is particularly useful when used in touch panel applications.

Thus, still further aspect of the present invention concerns a touch panel, comprising the transparent conductor according to the present invention.

Alternatively, the transparent conductor according to the present invention can be advantageously used in forming transparent electrode suitable in building OLED devices, especially in OLED lighting, as the OLED application often requires a formation of thin-film transparent electrode having smooth surface profile, and optionally good current density and/or lateral carrier collection. Therefore, yet another aspect of the present invention concerns an OLED, comprising the transparent conductor according to the present invention.

Should the disclosure of any patents, patent applications, and publications which are incorporated herein by reference conflict with the description of the present application to the extent that it may render a term unclear, the present description shall take precedence.

The following examples are intended to describe the invention in further detail without the intention to limit it.

### EXAMPLES

### Example 1: Preparation of Transparent Conductor 1

This example was carried out using silver nanowire dispersion in which silver nanowires were characterized by a mean diameter of 38±5 nm and a mean length of 17±8 μm. The concentration of this formulation was 0.17% wt (on silver).

The ITO ink used was produced by Solvay having a primary particle size of around 23 nm and a secondary (in suspension) particle size of around 60 nm. The concentration used was 20 wt % (on ITO). The solvent was isopropoxy ethanol.

Substrate:

Borofloat glass 33, from Schott (50 mm×50 mm×2 mm) previously polished (CeO2) and washed.

The substrates were coated by spin coating.

The first step was the coating with the silver nanowire formulation by means of spin coating (200 to 1000 rpm for about 75 seconds). The coated samples were dried at 120° C. for 30 minutes.

The single layer of the silver nanowire on glass shows the optical and electrical properties as follows:

| | R/sq after 150° C., 1 hr | Transmission | Haze |
|---|---|---|---|
| | [Ω/sq] | [%] | [%] |
| Single layer of | 177 | 93.5 | 0.72 |
| silver nanowire | | | |

On top of these layers, an ITO layer was coated (using the formulations with 20% concentration) by spin coating (100 to 1000 rpm for about 35 seconds). The final double coating was then subjected to UV hardening (ITO ink contains a UV-curable binder). After that step, the sample was annealed at 150° C. for 1 hour, thereby forming the transparent conductor 1.

| | R/sq after 150° C., 1 hr | Transmission | Haze |
|---|---|---|---|
| | [Ω/sq] | [%] | [%] |
| Double layer of silver | 94 | 91.4 | 1.37 |
| nanowire and ITO | | | |

In order to measure the effect on aging, the single layer of silver nanowire and the double layer of silver nanowire and ITO were stored in ambient environment for 16 weeks of the storage. The transmission and haze values were unchanged. The sheet resistance of the single layer was increased by 24%, whereas the degree of change was no more than 15% in case of the double layer.

### Comparative Example 1: Preparation of Transparent Conductor 2

This example was carried out using silver nanowire dispersion in which silver nanowires were characterized by a mean diameter of 70±6 nm and a mean length of 8±2 μm. The concentration of this formulation in 2-propanol was 0.5% wt (on silver).

The ITO ink used was produced by Solvay having a primary particle size of around 23 nm and a secondary (in suspension) particle size of around 60 nm. The concentration used was 20 wt % (on ITO). The solvent was isopropoxy ethanol.

Substrate:

Borofloat glass 33, from Schott (50 mm×50 mm×2 mm) previously polished (CeO2) and washed.

The substrates were coated by spin coating.

The first step was the coating with the silver nanowire formulation by means of spin coating (200 to 1000 rpm for about 75 seconds). The coated samples were dried at 120° C. for 30 minutes.

The single layer of the silver nanowire on glass shows the optical and electrical properties as follows:

| | R/sq after 150° C., 1 hr | Transmission | Haze |
|---|---|---|---|
| | [Ω/sq] | [%] | [%] |
| Single layer of | 19.6 | 86.5 | 5.7 |
| silver nanowire | | | |

On top of these layers, an ITO layer was coated (using the formulations with 20% concentration) by spin coating (100 to 1000 rpm for about 35 seconds). The final double coating was then subjected to UV hardening (ITO ink contains a UV-curable binder). After that step, the samples were annealed at 150° C. for 1 hour.

| | R/sq after 150° C., 1 hr | Transmission | Haze |
|---|---|---|---|
| | [Ω/sq] | [%] | [%] |
| Double layer of silver | 12.1 | 84.6 | 5.8 |
| nanowire and ITO | | | |

1. A transparent conductor comprising:
a substrate; and
a conductive layer formed on the substrate, wherein the conductive layer comprises a first conductive medium comprising a plurality of metal nanowires, and a second conductive medium comprising a plurality of conductive nanoparticles,
wherein the conductive nanoparticles are selected from metal oxide nanoparticles, and the plurality of metal nanowires are embedded in a matrix of the metal oxide nanoparticles,
wherein the average diameter of the metal nanowires is from 20 nm to 50 nm, and the average particle size of the nanoparticles is from 10 nm to 30 nm, as measured by transmission electron microscope (TEM).

2. The transparent conductor according to claim 1, wherein the average diameter of the metal nanowires is from 25 to 45 nm.

3. The transparent conductor according to claim 1, wherein the average length of the metal nanowires is at least 10 μm.

4. The transparent conductor according to claim 1, wherein the second conductive medium is in physical contact and/or electrical connection with the first conductive medium.

5. The transparent conductor according to claim 1, wherein the metal nanowire is silver nanowire.

6. The transparent conductor according to claim 1, wherein the conductive nanoparticles are indium tin oxide (ITO) nanoparticles.

7. The transparent conductor according to claim 6, wherein a secondary average particle size of the indium tin oxide nanoparticles in solution is no more than 100 nm.

8. The transparent conductor according to claim 1, wherein the substrate is a flexible substrate.

9. The transparent conductor according to claim 1, wherein the conductive layer possesses at least one of the following characteristics:
a transparency to visible light of at least 80%,
a sheet resistance of no more than 1,000 Ω/square,
a haze of no more than 5%.

10. A method for forming the transparent conductor according to claim 1, comprising:
applying a first composition for forming the first conductive medium comprising the plurality of metal nanowires on a surface of the substrate; and
applying a second composition for forming the second conductive medium comprising the plurality of conductive nanoparticles on the surface of the substrate in which the first conductive medium is formed.

11. The method according to claim 10, wherein the content of the metal nanowires in the first composition is from 0.01 wt % to 1 wt %, relative to the total weight of the first composition.

12. The method according to claim 10, wherein the content of the conductive nanoparticles in the second composition is from 5 wt % to 55 wt %, relative to the total weight of the second composition.

13. A transparent conductor comprising a substrate and a conductive layer formed on the substrate, the conductive layer at least comprising a plurality of metal nanowires,
wherein the plurality of metal nanowires are embedded in a matrix of metal oxide nanoparticles,
wherein the conductive layer possesses all of the following characteristics:
a transparency to visible light of at least 90%
a sheet resistance of no more than 100 Ω/square
a haze of no more than 1.5%.

14. A transparent conductor comprising a substrate and a conductive layer formed on the substrate, the conductive layer at least comprising a plurality of metal nanowires and possessing a sheet resistance value R,
wherein the variation of the sheet resistance value R does not exceed ±15% after exposing the conductive layer for 16 weeks at ambient environment.

15. A touch panel, comprising the transparent conductor according to claim 1.

16. A touch panel, comprising the transparent conductor according to claim 13.

17. A touch panel, comprising the transparent conductor according to claim 14.

18. The transparent conductor according to claim 3, wherein the average length of the metal nanowires is at least 15 μm.

19. The transparent conductor according to claim 7, wherein a secondary average particle size of the indium tin oxide nanoparticles in solution is no more than 60 nm.

20. The method according to claim 11, wherein the content of the metal nanowires in the first composition is from 0.02 wt % to 0.5 wt %, relative to the total weight of the first composition.
